(19) United States
(12) Patent Application Publication
(10) Pub. No.: US 2018/0189905 A1
(43) Pub. Date: Jul. 5, 2018

(54) SYSTEM TO GENERATE REAL ESTATE LEADS AND RELATED METHODS

(71) Applicant: Robert PALMER, Lake Mary, FL (US)

(72) Inventor: Robert PALMER, Lake Mary, FL (US)

(21) Appl. No.: 15/862,048

(22) Filed: Jan. 4, 2018

Related U.S. Application Data
(60) Provisional application No. 62/442,099, filed on Jan. 4, 2017.

(51) Int. Cl. G06Q 50/16; B42D 15/02; G06Q 30/02

(52) U.S. Cl. CPC G06Q 50/16; G06Q 30/0267; G06Q 30/0257; B42D 15/02

(57) ABSTRACT

A method to generate real estate leads includes publishing a plurality of marketing items for a real estate listing with a telephone number and a unique code printed thereon. The unique code is configured to be transmitted by a mobile communication device and the unique code printed on each piece of the plurality of marketing items is different. The method also includes sending the plurality of marketing items to a plurality of street addresses, where the unique code is assigned to a particular street address of the plurality of street addresses. In addition, the method includes receiving a communication from the mobile communication device at the remote device associated with the telephone number, where the communication includes the unique code, and in response to receiving the unique code, determining the particular street address assigned to the unique code and creating a file that stores data of the communication.

### RELATED APPLICATION

The present invention is related to U.S. Provisional Patent Application Ser. No. 62/442,099 filed Jan. 4, 2017, the entire contents of which are incorporated herein by reference.

### FIELD

The present invention relates to the field of real estate, and, more particularly, to a system to generate real estate leads and related methods.

### BACKGROUND

Real estate marketing and sales is often left to the ability of the real estate brokers and their agents. Traditional means of carrying out real estate marketing are replete with inefficiency and other shortcomings and limitations. These shortcomings include the inability to generate a number of good leads of those that may be interested in buying or selling a home. Typically, a broker will do a mass direct mail campaign that can be expensive and result in very few good leads.

In addition, the real estate industry has traditionally relied on the interpersonal skills of the real estate brokers and their agents. Although computer technology has been used to automate the collection and distribution of real estate multiple listing information, little else has been done to improve the targeting of potential leads.

For example, existing marketing systems have been used to automate the marketing process in various industries. However, the existing marketing systems have been designed to facilitate complex, multi-person sales activity between manufacturers and their business customers and do not translate well to the consumer markets such as the real estate market. Similarly, existing marketing systems that are used in the consumer markets such as contact management systems, telemarketing systems, and mail order processing systems also do not begin to address the particular aspects of real estate marketing. Thus, the existing marketing systems all suffer from similar common weaknesses that they either provide no means for improving efficiency over time, or they place the burden of improvement on user-supplied rules.

To illustrate the uniqueness of the single family real estate market, consider some of the issues faced by the broker. First, the home is the most substantial asset that most buyers will ever own. The decision to buy or sell a home is an emotional one and many people may take a long time to commit that they are ready to buy or sell. Then, even if their home buying or selling readiness is high, there is the issue of locating a suitable property, obtaining financing, finding a buyer for a person's existing property, and so forth. All of these emotional uncertainties make the real estate business highly labor intensive. It has been very costly and inefficient to locate ready buyers and sellers using conventional mailing lists and telemarketing campaigns. Simply stated, there has been no way to predict which members of the potential customer population represent good leads on which to follow up.

Real estate brokers have traditionally relied heavily on their real estate agents to meet the potential customer population face to face, to identify the best buyer and seller candidates. This presents a significant problem for the broker who is trying to increase market share while protecting profit margins. In this labor-intensive industry, increasing market share has traditionally required increasing the number of agents. Increasing the number of agents does not translate to increased productivity and efficiency since after a point the best agents have already been taken. In fact, increasing the number of agents can actually reduce efficiency. What is needed is system to increase the overall efficiency of the entire marketing process for the broker, the agents and the public.

Accordingly, by directing a marketing campaign to those that are most likely interested in buying or selling a home, the broker can be most cost effective with his or her marketing budget. A marketing system and method is needed where a broker can generate numerous good real estate leads in a cost effective manner.

### SUMMARY

In view of the foregoing background, it is therefore an object of the present invention to provide a system and method to generate real estate leads that can be used to help sell a property or secure a new real estate listing. The method includes publishing a plurality of marketing items for a real estate listing with each having a telephone number and a unique code printed thereon, where the unique code is configured to be transmitted by a mobile communication device to a remote device associated with the telephone number.

In addition, the method includes sending the plurality of marketing items to a plurality of street addresses, where the unique code is assigned to a particular street address of the plurality of street addresses, and receiving a communication from the mobile communication device at the remote device associated with the telephone number, where the communication includes the unique code.

The method also includes that in response to receiving the unique code, determining the particular street address assigned to the unique code, and creating a file that stores data of the communication. The unique code is a text message having alphanumeric characters. In a particular embodiment, the mobile communication device is a smartphone and the unique code printed on each piece of the plurality of marketing items is different.

Thus, additional marketing materials can be directed to that street address assigned to that unique code. Not only can additional marketing information be directed to the resident of that street address (i.e., home), but that resident could also be a potential lead for a listing of their home.

In another embodiment, a system to generate real estate leads includes a plurality of marketing items for a real estate listing with each having a telephone number and a unique code printed thereon. The unique code is configured to be transmitted by a mobile communication device to a remote device associated with the telephone number. The system also includes a server having a microprocessor and a memory that stores the unique code assigned to a particular street address of the plurality of street addresses.

The microprocessor is configured to receive a communication from the mobile communication device at the remote device associated with the telephone number, where the communication includes the unique code. In response to receiving the unique code, the system determines the particular street address assigned to the unique code, and creating a file that stores data of the communication.

One advantage of a particular illustrative embodiment of the invention is that a targeted marketing campaign can be directed to a particular geographic area to generate leads. For example, when that unique code is received asking for more information about a listing, it can be readily determined from which street address that inquiry originated.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a flow diagram of a particular illustrative embodiment of a method to generate real estate leads;

FIG. 2 is a diagram of a particular illustrative embodiment of a system to generate real estate leads;

FIG. 3 is a general diagram of a system incorporating a microprocessor and a memory in which the system and method of FIGS. 1 and 2 to generate real estate leads may be used; and

FIG. 4 is a particular illustrative embodiment of a marketing item that may be used with the system and method to generate real estate leads.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

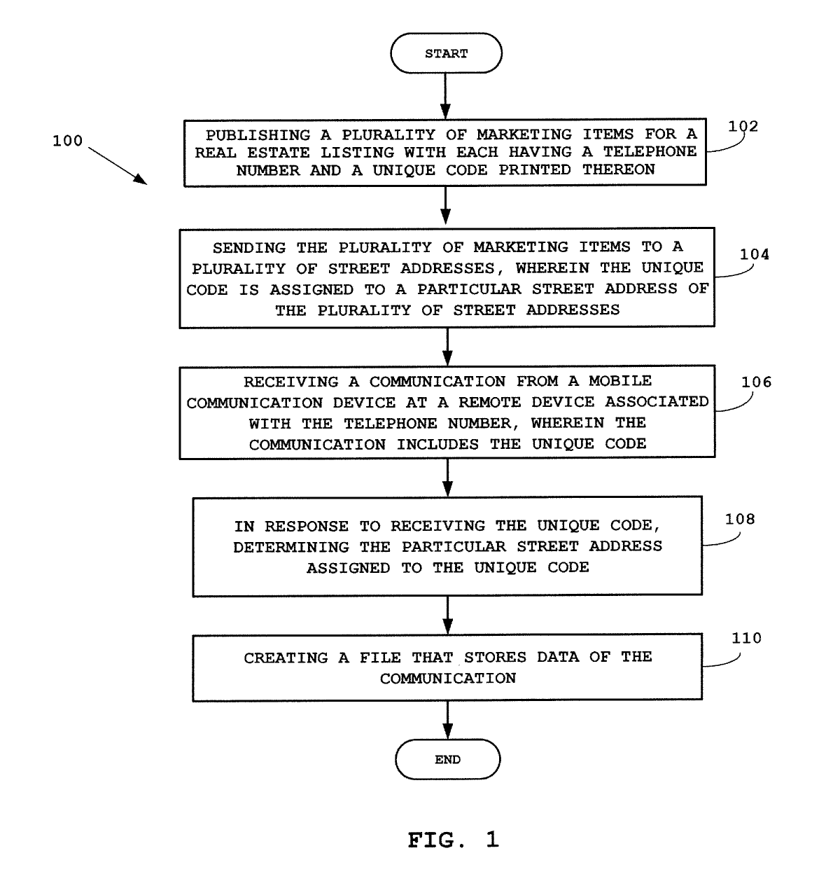

Referring initially to FIG. 1, a method to generate real estate leads is generally designated 100. The method begins with publishing a plurality of marketing items for a real estate listing with each having a telephone number and a unique code printed thereon, at 102, where the unique code is configured to be transmitted by a mobile communication device to a remote device associated with the telephone number. The unique code may be randomly generated by a random generator. Moving to 104, the method includes sending the plurality of marketing items to a plurality of street addresses, where each unique code is assigned to a particular street address of the plurality of street addresses. The sending of the plurality of marketing items to the plurality of street addresses comprises using a mailing service to deliver the plurality of marketing items to the plurality of street addresses, for example the U.S. Postal Service.

In addition, the method includes, at 106, receiving a communication from a mobile communication device at a remote device associated with the telephone number, where the communication includes the unique code. The method also includes in response to receiving the unique code, determining the particular street address assigned to the unique code, at 108.

The method includes creating a file that stores data of the communication, at 110, that can be used to direct more marketing to the resident of the particular street address that responded.

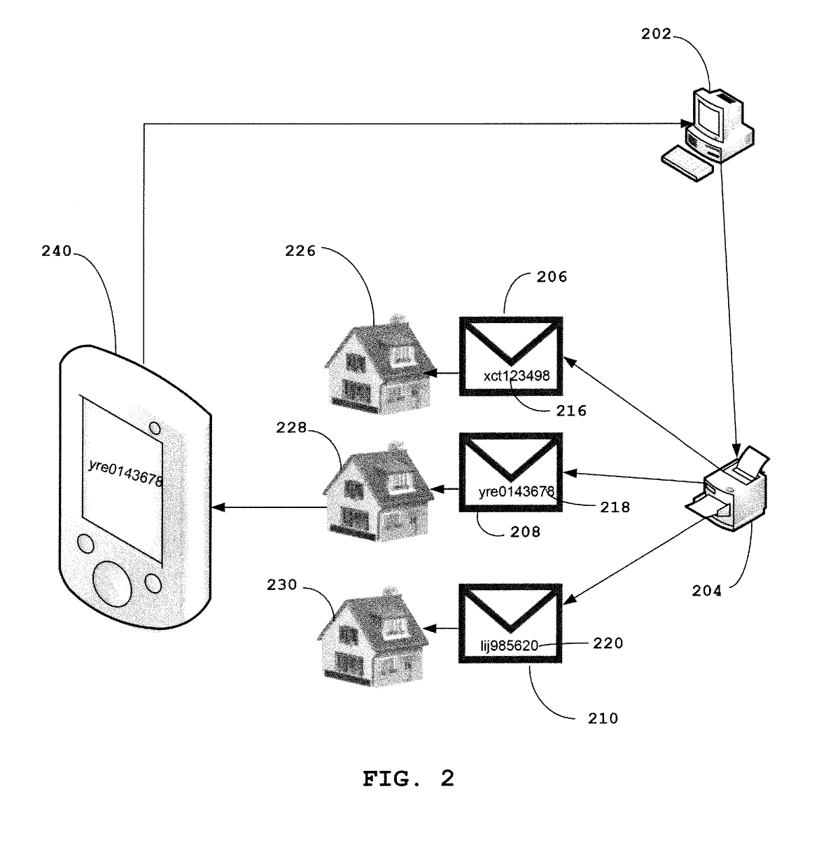

A system to generate real estate leads is shown in FIG. 2 and designated 200. The system 200 includes a remote computer 202 in communication with a printer 204. The remote computer 202 stores a database of unique codes that are assigned to street addresses in a relational database. For example, a first unique code is assigned to a first street address, and a second unique code is assigned to a second street address, and so on. The printer 204 is used to publish (or print) the marketing materials 206, 208, 210. Each piece of marketing material includes a street address for a home 226, 228, 230.

Accordingly, a first piece of marketing material 206 includes a first unique code 216 and the first street address for the home 226. The first unique code is “xct123498”. The first piece of marketing material is then mailed to the first street address 226. Similarly, a second piece of marketing material 208 includes a second unique code 218 and a second street address for the home 228. The second unique code is “yre0143678”. Likewise, the third piece of marketing material 210 includes a third unique code 220 and a third street address for the home 230. The third unique code is “lij985620”. The unique codes can be randomly generated, or sequential, for example.

When a resident of the home that received the marketing material wants more information about the listing printed thereon, the recipient can use a mobile communication device 240 to text a phone number with a message having the unique code. The unique code can then be correlated with the respective street address stored in the remote computer using the relational database in order to determine the resident that is responding.

For example, in FIG. 2 the mobile communication device 240 from the second street address 228 is texting the message “yre0143678.” Thus, when that text message is received, that unique code can be correlated to whatever street address to which it was assigned. Subsequently, additional marketing material can be directed to the second street address as a lead who is interested in buying or selling a home.

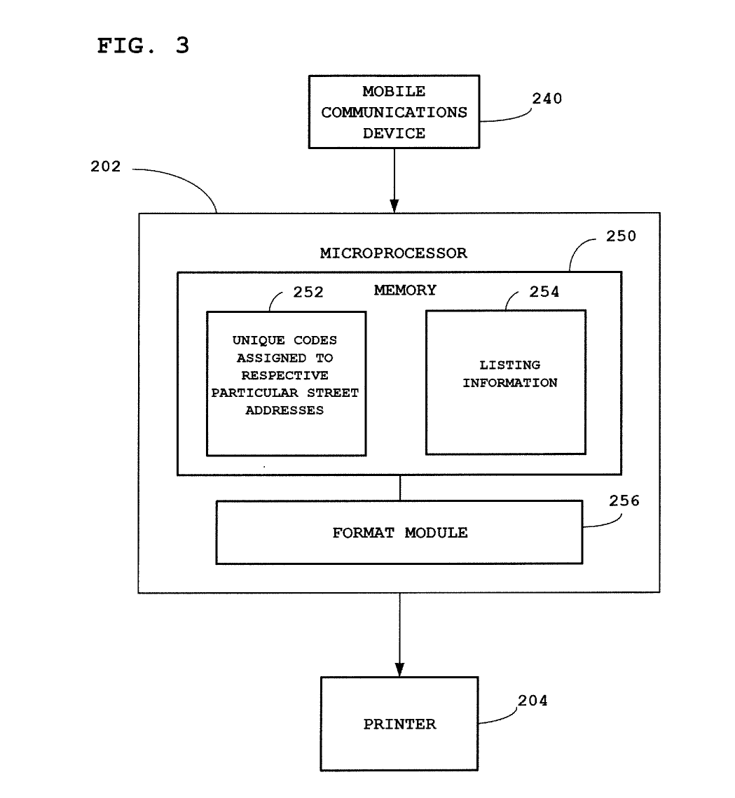

FIG. 3 is a general diagram of the remote computer 202, which includes a microprocessor and a memory 250. The memory 250 is used to store the unique codes assigned to the respective particular street addresses, and also listing information 254 and any other information related to the real estate. A format module 256 includes an algorithm that is executed by the microprocessor in order to format the unique codes and the listing information and any other information related to the real estate into the desired marketing format. The remote computer 202 transmits the formatted marketing material to a printer 204 that generates the physical marketing materials, which can then be delivered to desired recipients.

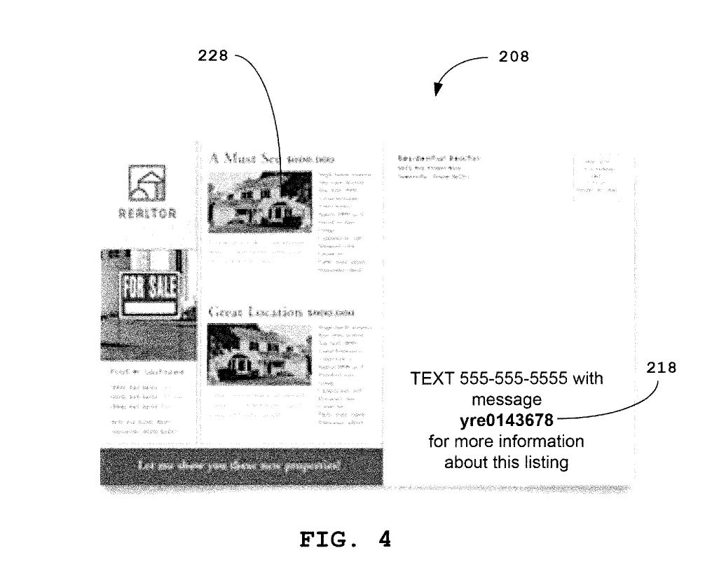

Referring now to FIG. 4, a postcard is illustrated as an example of the marketing material 208. The postcard includes listing information for the second home 228 and also the telephone number that a recipient can text the message “yre0143678”, which is the second unique code 218. As explained above, once a message is received with the unique code, the broker can determine from which street address the message was received. The unique code can also be correlated with the particular listing, or the telephone number can be used as the identifier of a particular listing.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

That which is claimed is:

1. A method to generate real estate leads, the method comprising:
publishing a plurality of marketing items for a real estate listing with each having a telephone number and a unique code printed thereon, wherein the unique code is configured to be transmitted by a mobile communication device to a remote device associated with the telephone number;
sending the plurality of marketing items to a plurality of street addresses, wherein the unique code is assigned to a particular street address of the plurality of street addresses;
receiving a communication from the mobile communication device at the remote device associated with the telephone number, wherein the communication includes the unique code; and
in response to receiving the unique code, determining the particular street address assigned to the unique code, and creating a file that stores data of the communication.

2. The method of claim 1, wherein the unique code comprises alphanumeric characters.

3. The method of claim 1, wherein the mobile communication device is a smartphone.

4. The method of claim 1, wherein the unique code printed on each piece of the plurality of marketing items is different.

5. The method of claim 1, wherein the unique code is randomly generated.

6. The method of claim 1, wherein the marketing item comprises a post card.

7. The method of claim 1, wherein the communication from the mobile communication device is a text message.

8. The method of claim 1, wherein the sending of the plurality of marketing items to the plurality of street addresses comprises using a mailing service to deliver the plurality of marketing items.

9. A system to generate real estate leads, the system comprising:
a plurality of marketing items for a real estate listing with each having a telephone number and a unique code printed thereon, wherein the unique code is configured to be transmitted by a mobile communication device to a remote device associated with the telephone number;
a server comprising a microprocessor and a memory that stores the unique code assigned to a particular street address of the plurality of street addresses, the microprocessor configured to
receive a communication from the mobile communication device at the remote device associated with the telephone number, wherein the communication includes the unique code; and
in response to receiving the unique code, determining the particular street address assigned to the unique code, and creating a file that stores data of the communication.

10. The system of claim 9, wherein the unique code comprises a text message comprising alphanumeric characters.

11. The system of claim 9, wherein the mobile communication device comprises a smartphone.

12. The system of claim 9, wherein the unique code printed on each piece of the plurality of marketing items is different.

13. The system of claim 9, wherein the unique code is randomly generated.

14. The system of claim 9, wherein the marketing item comprises a post card.

15. The system of claim 9, wherein the communication from the mobile communication device is a text message.

16. The system of claim 9, wherein the sending of the plurality of marketing items to the plurality of street addresses comprises using a mailing service to deliver the plurality of marketing items.

17. A method to generate real estate leads, the method comprising:
publishing a plurality of marketing items for a real estate listing with each marketing item having a randomly generated unique code printed thereon, wherein the unique code is configured to be transmitted by a mobile communication device to a remote device;
receiving a communication from the mobile communication device at the remote device, wherein the communication includes the unique code; and
in response to receiving the unique code, determining a particular street address assigned to the unique code using a relational database, and creating a file that stores data of the communication.

18. The method of claim 17, wherein the mobile communication device is a smartphone.

19. The method of claim 17, wherein the unique code printed on each piece of the plurality of marketing items is different.

20. The method of claim 17, wherein the communication from the mobile communication device is a text message.
